(19) United States
(12) Patent Application Publication
(10) Pub. No.: US 2006/0156615 A1
(43) Pub. Date: Jul. 20, 2006

(54) Snap trap enclosure for trapping and killing rodents

(76) Inventor: Brian Hale, Arnold (CA)

Correspondence Address: THE INVENTORS NETWORK, INC., 332 ACADEMY STREET, CARNEGIE, PA, 15106, US

(21) Appl. No.: 11/035,859

(22) Filed: Jan. 18, 2005

(51) Int. Cl. A01M 23/16; A01M 23/30

(52) U.S. Cl. 43/58; 43/81

(57) ABSTRACT

A device for trapping and killing rodents includes a long, narrow box-like enclosure having an entrance opening at a first end through which the rodent passes face first into the enclosure, and an opposite rear end having rear wall from which a bait shelf inwardly projects for the placement of bait thereon, with a snap trap located between the entrance opening and the bait so that the rodent must walk over the trap at the trap's most lethal orientation which is straight forward thereby unavoidably triggering the trap and killing the rodent. A pair of clips positioned within the enclosure adjacent the rear wall secure the trap in position and prevent the trap from flipping up when triggered, and the both the rear wall and the roof are hinged so that they can be opened for replacing the bait without disturbing the trap and for removing both the bait and trapped rodent so that the enclosure can be re-baited and the trap reset or replaced.

### FIELD OF THE INVENTION

The present invention pertains to devices for trapping and killing rodents, and more particularly pertains to an enclosure with bait and a trap located therein, and which compels the rodent to enter the enclosure face first so that the rodent trips the trap at the trap's most lethal orientation with respect to the rodent.

### BACKGROUND OF THE INVENTION

Rodents are both enormously prolific and enormously destructive creatures, capable of surviving in almost all natural habitats and easily adaptable to living in and among human environments and settings. Because of their destructiveness and the fact that they are vectors for numerous lethal diseases ranging from Lyme disease to bubonic plague, their control and extermination has been a constant human concern and project from our earliest civilizations to the present day.

The trapping and extermination of rodents—rats and mice—is generally accomplished using various types of poison or spring traps. There are obvious drawbacks to the use of both types of rodent extermination methods. The use of poisons is problematic in so far as the poison may be accidentally ingested by children, family pets, unintended animals, or livestock, resulting in needless injury or death. In addition, even if the rodents ingest the poison, or the poisoned bait, poisonous residue can still remain, and so the site must be thoroughly cleaned and monitored. Moreover, environmental and health regulations strictly control, and in many cases, prohibit the use of poisons for rodent control.

Thus, snap traps are the preferred form of rodent control and extermination. But, the use of snap traps, as stand-alone rodent trapping devices, also has drawbacks. Snap traps are designed for the rodent to take the bait from the front or front side of the trap. This is the only angle or approach for the rodent to get caught by the trap bar as the trap bar flips forward. However, many times the rodent will approach the trap from behind or at an angle that doesn't properly trigger the trap. In addition, depending on the age and quality of the particular trap, some traps have triggers that stick or prematurely go off because the triggers are to sensitive. Rodents are also clever in that they are able to eat the bait off the trap if they are careful, and can do so without setting off the trap. Further, depending on the size and bulk of the trap, some trips have the tendency to flip up when set off because of the force of the trap bar rapidly pivoting from one side of the trap to the other side. Such violent action actually throws the trap away from the rodent allowing the rodent to escape. Generally, the base of the trap is too light to hold the trap in place throughout the pivoting and triggering motion of the trap bar. Finally, snap traps can be dangerous in that they can injure or break fingers or toes of not only children but adults as well, and they can seriously injure and fatally wound family pets, such as small dogs and cats. Thus, the prior art reveals numerous improvements to the standard snap trap for trapping and killing rodents.

For example, the Marotti patent (U.S. Pat. No. 4,062,142) discloses an apparatus for trapping and killing rodents whereby the taking of bait by the rodent causes an electrically activated door to close trapping the rodent inside so that the rodent can be killed by a poison gas.

The Murakami patent (U.S. Pat. No. 4,429,483) discloses a box-like device that includes a pair of upper closure plates that open when the rodent takes the bait thereby causing the rodent to fall into a container of viscous liquid.

The Tsai patent (U.S. Pat. No. 4,553,349) discloses a mousetrap that includes a housing mounted on a liquid-filled tank so that the mouse entering the housing triggers a switch that causes a drop floor section to be released resulting in the rodent being dropped into and drowning in the tank.

The Van Dijnsen et al. patent (U.S. Pat. No. 5,040,326) discloses a rodent killing system that includes a luring box into which rodents enter through an entrance hole, a suction unit connected to the luring box and maintained under vacuum to draw the rodents therein from the luring box, and a registration unit for detecting and counting the number of rodents that enter the luring box and are drawn into the suction unit.

The McCuistion, III, et al. patent (U.S. Pat. No. 5,265,371) discloses a rat trap that includes a containment chamber and an inner containment chamber inserted therein. The containment chamber includes a pair of doors that are sprung by a microswitch when the bait is taken thereby causing the rodent to fall into the inner containment chamber.

The Celestine patent (U.S. Pat. No. 6,016,623) discloses a rodent trap that includes a housing that slidably receives a rodent box. A motor and cam arrangement causes a trap door to open when a switch is tripped thereby causing the rodent to fall into the rodent box.

The Ronnau patent (U.S. Pat. No. 6,088,948) discloses a method and device for trapping and killing rodents that includes an entrance pipe connecting to a box-like housing unit with the housing unit sitting atop a killing unit. Rodents enter the housing unit through the entrance pipe whereupon they are killed by the release of a poison chemical, and then a trap door opens to drop them into the killing unit.

Despite the ingenuity of the above device, there remains a need for a rodent trapping and killing device that is easy to use, does not involve the use of sensors, switches, or poisonous chemicals, and provides the rodent with no opportunity to avoid the trap while going for the bait.

### SUMMARY OF THE INVENTION

The present invention comprehends a lightweight, portable device for trapping and killing rodents in a safe, efficient and effective manner. The device comprises a box-like enclosure having a hinged roof and a hinged end wall, and an entrance hole opposite the end wall and through which rodents can enter the enclosure. A bait shelf for placing bait thereon projects from the interior of the end wall and a trap is placed on the enclosure floor between the entrance hole and the bait shelf. The long, narrow configuration of the box-like enclosure forces the rodent to enter face first and to approach the bait directly, and thus to come in at the trap's most lethal orientation which is straight forward. Thus, in order to reach the bait the rodent must walk over the trap. The end wall is hinged so that bait can be placed on the bait shelf and replaced after being taken by the rodent, and the roof is also hinged to allow for the removal of the trapped and killed rodent so that the trap can be reset. The trap with the dead rodent can also be slid out of the enclosure by opening the rear wall. A pair of hold-down clips are mounted to the floor of the enclosure for holding the trap in place and preventing the trap from flipping up when triggered and possibly resulting in the rodent escape trapping.

It is an objective of the present invention to provide a snap trap enclosure for trapping and killing rodents that is safe, reliable and lethal.

It is another objective of the present invention to provide a snap trap enclosure for trapping and killing rodents that avoids the problem and frustration of stolen bait and failed trap triggers.

It is still another objective of the present invention to provide a snap trap enclosure for trapping and killing rodents that holds the trap in place within the enclosure and secures the trap from flipping upward when tripped thereby allowing the rodent to escape from being trapped.

It is still yet another objective of the present invention to provide a snap trap enclosure for trapping and killing rodents that forces the rodent to directly face the trap at the trap's most lethal orientation because of the long, narrow dimensions of the enclosure.

It is still yet a further objective of the present invention to provide a snap trap enclosure for trapping and killing rodents that avoids exposing the trap or rodent to curious pets and children, and is thus safer to use and protects pets or children from injury.

A further objective of the present invention is to provide a snap trap enclosure for trapping and killing rodents that is preferably manufactured from plastic so that the enclosure is lightweight, inexpensive and . capable of being mass-produced and easily moved or transported from site to site.

A still further objective of the present invention is to provide a snap trap enclosure for trapping and killing rodents that includes only a single entrance and a dark, narrow passageway that draws the rodent in and forces the rodent to step over the trap to reach the bait thereby setting off the trap at the trap's most lethal orientation and trapping the rodent before the rodent reaches the bait.

A still yet another objective of the present invention is to provide a snap trap enclosure for trapping and killing rodents that removes any angles and options that allow the rodent to steal the bait or avoid triggering the trap.

Still a further objective of the present invention is to provide a snap trap enclosure for trapping and killing rodents that can be over-baited for attracting more rodents.

Yet another objective of the present invention is to provide a snap trap enclosure for trapping and killing rodents that is re-usable in so far as after one rodent is trapped and killed within the enclosure, that rodent can be removed so that fresh bait and a new trap can be placed within the enclosure.

Yet still another objective of the present invention is to provide a snap trap enclosure for trapping and killing rodents which allows for the placement and replacement of bait within the enclosure without disturbing or setting off the trap.

These and other objects, features and advantages will become apparent to those skilled in the art upon a perusal of the following detailed description read in conjunction with the accompanying drawing figures.

### BRIEF DESCRIPTION OF THE DRAWINGS

FIG. 1 is a perspective view of the snap trap enclosure of the present invention illustrating the entrance hole for the rodents;

FIG. 2 is a perspective view of the snap trap enclosure of the present invention illustrating the internal disposition of trap and the bait shelf;

FIG. 3 is a sectioned elevational view of the enclosure taken along lines 3-3 of FIG. 1 illustrating the disposition of the trap and the location of the bait on the bait shelf; and

FIG. 4 is a sectioned plan view of the enclosure taken along lines 4-4 of FIG. 1 illustrating the rodent passing through the entrance hole, approaching the bait face forward and contacting the trap trigger thereby resulting in the activation of the trap to kill the rodent.

### DETAILED DESCRIPTION OF THE PREFERRED EMBODIMENT

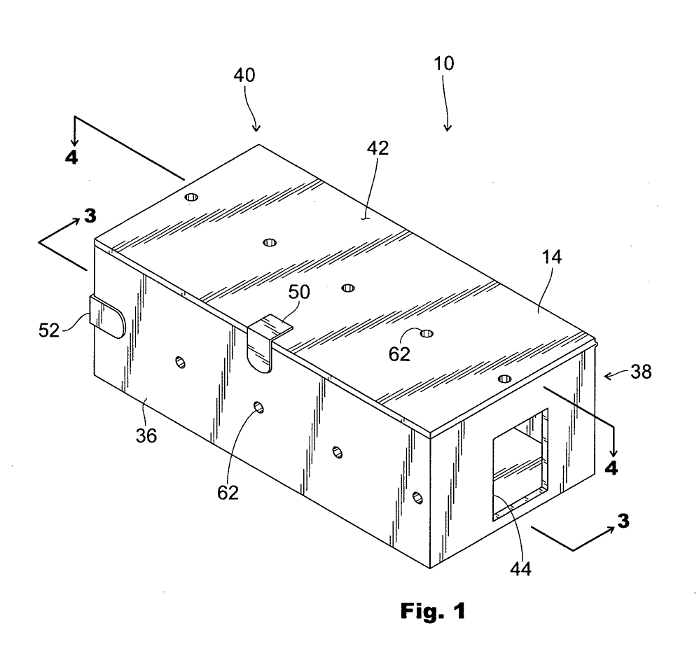

Illustrated in FIGS. 1-4 is a device 10 for trapping and killing rodents 12 that is lightweight, portable, and constructed primarily from plastic sheeting. The device 10 is characterized by a rectangular, box-like enclosure 14 of a generally long, narrow configuration that makes it unavoidable for the rodent 12 to set off a snap trap 16 that is placed therein once the rodent 12 enters the enclosure 14 face first and moves toward the bait 18. The snap trap 16 includes a base 20 and a coil spring 22 mounted to the base 20 by brackets 24. A trap or trigger tray 26 is joined to the coil spring 22 and extending from the distal ends of the spring 22 is a unshaped trap bar 28 that is held in position by a trap arm 30 that is set against a catch 32 on the trap tray 26. The weight of the rodent 12 on the trap tray 26 causes the trap tray 26 to pivot thereby releasing the trap arm 30, and the release of the trap arm 30 immediately causes the trap bar 28 to forcibly pivot towards the trap tray 26 thereby trapping the rodent 12 between the trap bar 28 and the trap tray 26 and killing the rodent 12.

The box-like enclosure 14, as illustrated in FIGS. 1-4, includes a floor 34, a pair of opposed sidewalls 36, an entrance end 38 and an opposite rear end 40, and a roof 42. The entrance end 38 is further defined by an entrance opening 44 sized so that the rodent 12 must enter and pass through the entrance opening 44 face first. The rear end 40 is further defined by a rear or end wall 46, and the floor 34, the roof 42, the sidewalls 36, the entrance end 38 and the rear wall 46 define an interior rodent confinement chamber 48 for placement therein of the snap trap 16. The long, narrow configuration of the confinement chamber 48 simulates a dark, hole-like structure and appearance for drawing the rodent 12 therein.

In order to provide for easy access to the confinement chamber 48, for placing and replacing the bait 18 and for resetting and replacing the trap 16, and for the removal of the dead rodent 12, the roof 42 and the rear wall 46 are hingably or pivotally mounted to one sidewall 36. Both the rear wall 46 and the roof 42 can be locked to the opposite sidewall 36 to deny access to the confinement chamber 48 for preventing individuals, primarily children, and house pets, such as cats and small dogs, from reaching into the enclosure 14 setting off the trap 16 and risking injury and possibly death. Thus, as shown in FIGS. 1-4, the roof 42 includes a roof snap lock 50 centrally located at the free edge of the roof 42, and the rear wall 46 includes a snap lock 52 located at the free side of the rear wall 46. The opposite sidewall 36 includes a pair of spaced-apart receiving snaps 54 with one receiving snap 54 located adjacent the free swinging side of the rear wall 46 and the other receiving snap 54 located on the upper central portion of the sidewall 36. The enclosure 14 can be locked shut by engaging the roof snap lock 50 and the snap lock 52 to the corresponding receiving snaps 54, thereby closing the confinement chamber 48 to external access; and the enclosure 14 can be easily and quickly unlocked for gaining access to the confinement chamber 48 by disengaging the roof snap lock 50 and the snap lock 52 from the corresponding receiving snaps 54.

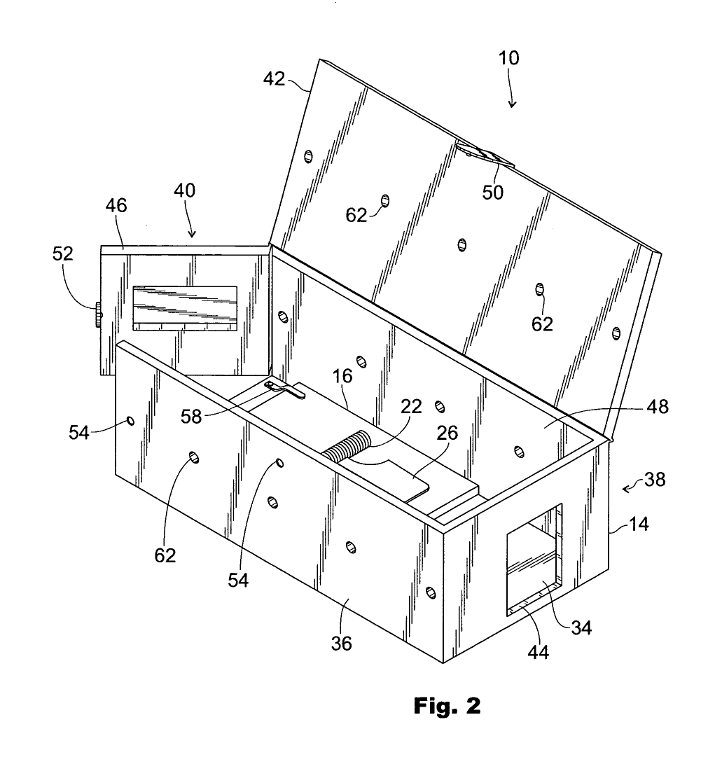

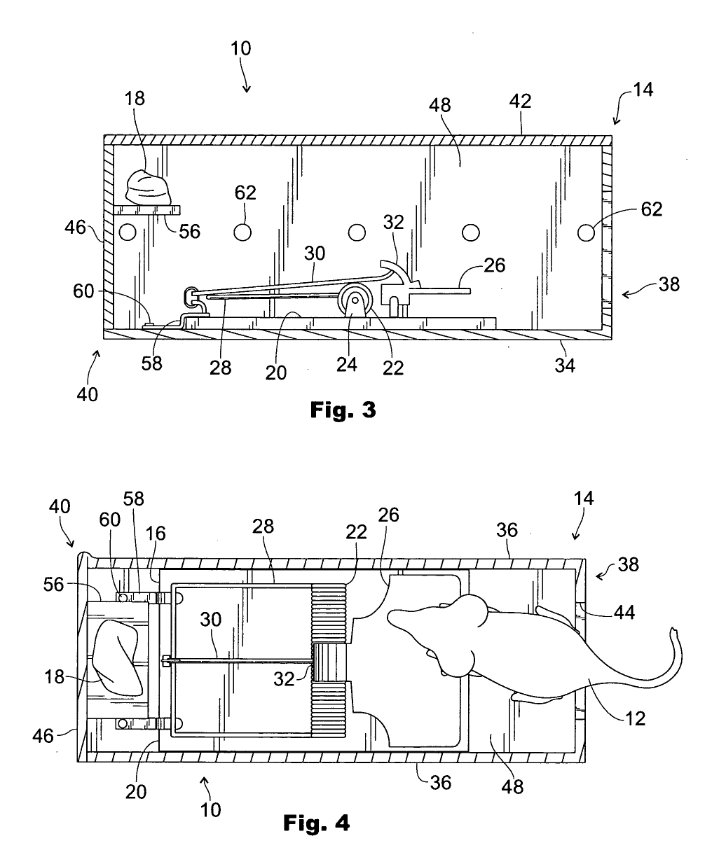

Attached to the rear wall 46 and projecting into the confinement chamber 48, as shown in FIGS. 3 and 4, is a bait shelf 56 for placement thereon of the bait 18 to entice the rodent 12 into the confinement chamber 48. The bait shelf 56 can be over-baited to attract more rodents 12 to the enclosure 14, especially if there are numerous rodents 12 in the area that require some period of time to exterminate. The bait 18 can be placed on the bait shelf, and replaced as needed, by simply unlocking the rear wall 46 and swinging it rearward without ever disturbing the trap 16. Because the snap trap 16 will often flip upward when set off from the inertia of the trap bar 28 rapidly pivoting toward the trigger tray 26, the present invention includes a means to hold the trap 16 in place within the confinement chamber 48 when set off by the rodent 12. Specifically, the hold down means includes a pair of clips 58 mounted to the floor 34 of the enclosure 14 adjacent the rear wall 46 by fasteners 60, such as screws. A portion of the trap base 20 is slid or wedged between each clip 58 and the floor 34 for maintaining the disposition of the trap 16 in its pre-sprung state and when the trap 16 is set off from the action of the rodent 12. Because the rodent 12 may be trapped and killed within the confinement chamber 48 of the enclosure 14, and may remain therein for several days before the individual checks the device 10, the box-like enclosure 14 includes vents 62 for dissipating any odor that may accumulate within the confinement chamber 48 from the dead and decaying rodent 12. The vents 62 are disposed on the sidewalls 36 and the roof 42, and the arrangement of the vents 62 as shown in FIGS. 1 and 2 is one possible arrangement.

After the site has been determined, the individual can open either the rear wall 46 or the roof 42, or both, to place the bait 18 on the bait shelf 56 and set the trap 16 as shown in FIG. 3. The trap 16 is further secured to the floor 34 of the enclosure 14 by sliding or wedging the base 20 of the trap 16 beneath the clips 58. The enclosure 14 is then snapped shut and locked preventing anyone or any creature from gaining access to the interior confinement chamber 48, and the only access into the confinement chamber 48 is through the entrance opening 44. The long, narrow, rectangular configuration of the enclosure 14 accomplishes two goals in that the dark area lures the naturally curious rodent 12, and, second, the long, narrow configuration forces the rodent 12 to pass through the entrance opening 44 face first, and continue moving within the confinement chamber 48 face first. The snap trap 16 that is positioned between the rodent 12 and the bait 18 on the bait shelf 56 is automatically set off as the rodent 12 steps on and walks over the trap 16 in an attempt to reach the bait 18. The rodent 12 sets off the trap 16 at the trap's 16 most lethal angle or orientation, which is coming at the trap 16 straight forward. When the rodent 12 is killed only the tail of the rodent 12 will be visible from outside the enclosure 14, thereby eliminating the sight of the dead rodent 12. The roof 42 and/or the rear wall 46 can then be unlocked to remove the rodent 12, reset or replace the trap 16, and to re-bait the bait shelf 56. The snap trap 16 with the rodent 12 trapped thereon can be slid out by unlocking and opening the rear wall 46, and then a new trap 16 can be slid within the enclosure 14, thus making the device 10 continuously reusable.

Although the invention has been described and illustrated with respect to a preferred embodiment, it is not to be so limited since numerous changes, alterations, and modifications may be made therein that are within the full intention of the scope of the invention and the appended claims.

I claim:

1. A device for trapping and killing rodents, comprising:
a box-like enclosure having a floor, a pair of opposed sidewalls, an entrance end, an opposite rear wall, a roof pivotally secured to one side wall for selective opening and closing, and the floor, sidewalls, rear wall and entrance end defining a confinement chamber wherein the trapping and killing of the rodent occurs;
the entrance end including an entrance opening for allowing the rodent to enter the confinement chamber;
the rear wall having a bait shelf projecting therefrom into the chamber and upon which bait for the rodent can be placed;
a pair of clips mounted to the floor adjacent the rear wall for holding the trap in place after the trap has been tripped by the rodent walking over the trap to reach the bait;
the rear wall hingably attached to one side wall so that the rear wall can be selectively opened for replacing the bait on the bait shelf and for removing or resetting the trap and removing the rodent;
the roof being openable to replace the bait on the bait shelf and for removing the rodent from the trap and for removing or resetting the trap; and
a plurality of vents disposed on the sidewalls and the roof for allowing air to pass through the enclosure in order to dissipate the smell from the dead rodent that has been caught in the trap.

2. The device for trapping and killing rodents of claim 1 wherein the rear wall includes a snap lock.

3. The device for trapping and killing rodents of claim 2 wherein the roof includes a roof snap lock.

4. The device for trapping and killing rodents of claim 3 wherein one sidewall includes a pair of receiving snaps that are capable of engagement to the snap lock and the roof snap lock so that the rear wall and the roof can be closed and locked against the sidewall and disengaged therefrom so that the rear wall and the roof can be opened for allowing access to the bait, the trap and the rodent within the confinement chamber.

5. A device for trapping and killing rodents, comprising:
a box-like enclosure having a floor, a pair of opposed sidewalls, an entrance end, an opposite rear end, and a floor defining a long, narrow rodent confinement chamber wherein the trapping and killing of the rodent occurs;
the entrance end having an entrance opening for allowing the rodent to enter into the confinement chamber;
the rear end having a rear wall;
a bait shelf projecting from the rear wall into the confinement chamber and on which bait for the rodent can be placed;
a pair of clips mounted to the floor adjacent the rear wall for holding the trap in place within the confinement chamber and for inhibiting the trap from flipping upward upon being tripped by the rodent;
a plurality of vents disposed on the sidewalls and the roof for dissipating any order that may emanate from the trapped rodent; and
the trap being located between the bait shelf and the entrance opening so that the rodent must pass through the entrance opening and enter the confinement chamber face first whereupon the rodent is oriented to the trap's most lethal angle which is straight forward and in order to reach the bait on the bait shelf the rodent must walk over the trap resulting in the rodent triggering the trap at the trap's most lethal angle thereby insuring the trapping of the rodent.

6. The device for trapping and killing rodents of claim 5 wherein the rear wall is pivotally securable to one sidewall so that the rear wall can be selectively opened and closed for the placement and replacement of bait on the bait shelf and for removal of the trapped rodent and the placement within the confinement chamber of another trap.

7. The device for trapping and killing rodents of claim 6 wherein the roof is pivotally securable to one sidewall so that the roof can be selectively opened and closed for the placement and replacement of bait on the bait shelf and for the removal of the trapped rodent and the placement within the confinement chamber of another trap.

8. The device for trapping and killing rodents of claim 7 wherein one sidewall includes at least two spaced-apart receiving snaps with one receiving snap located adjacent the pivotally securable sidewall and one receiving snap located in the upper middle portion of that sidewall.

9. The device for trapping and killing rodents of claim 8 wherein the pivotal rear wall includes a snap lock that is engagable to and disengagable from the adjacent receiving snap on the sidewall so that the rear wall can be pivotally locked to and unlocked from the sidewall thereby allowing or preventing access to the confinement chamber.

10. The device for trapping and killing rodents of claim 9 wherein the roof includes a roof snap lock that is engagable to and disengagable from the receiving snap located at the upper middle portion of the sidewall so that the roof can be pivotally locked to and unlocked from that sidewall thereby allowing or preventing access to the confinement chamber.

11. A device for trapping and killing rodents, comprising:
a box-like enclosure having a floor, a pair of opposed sidewalls, an entrance end, an opposite rear end, a roof secured to one side wall, and the floor, sidewalls, entrance end and rear end defining a confinement chamber wherein the trapping and killing of the rodent occurs;
the entrance end including an entrance opening forcing the rodent to enter face first the confinement chamber;
the rear end including a rear wall capable of being selectively opened and closed;
a bait shelf mounted to the rear wall and projecting into the confinement chamber and on which bait for the rodent is placed;
a pair of clips mounted to the floor adjacent the rear wall for holding the trap in place after the trap has been set off by the rodent walking over the trap to reach the bait;
the rear wall pivotally attached to one sidewall so that the rear wall can be selectively opened and closed for the placement and replacement of bait on the bait shelf and for the removal of the rodent and the setting, removal and replacement of the trap;
the roof being pivotally securable to the same side wall as the rear wall so that bait can be placed and replaced on the bait shelf and for the removal of the rodent and for the setting, removal and replacement of the trap; and
the trap being placed between the bait shelf and the entrance opening so that the rodent must pass through the entrance opening and enter the confinement chamber face first whereupon the rodent is oriented to the most lethal angle of the trap which is straight forward and in order to reach the bait on the bait shelf the rodent must walk over the trap resulting in the rodent setting off the trap at the trap's most lethal angle thereby insuring that the rodent is trapped and killed.

12. The device for trapping and killing rodents of claim 11 wherein the sidewalls and the roof include a plurality of vents that allow air to pass through the enclosure in order to dissipate the smell of the rodent that has been trapped and killed by the trap located in the confinement chamber.
